(19) United States
(12) Patent Application Publication
(10) Pub. No.: US 2013/0169631 A1
(43) Pub. Date: Jul. 4, 2013

(54) METHOD FOR RECONSTRUCTING A THREE-DIMENSIONAL MODEL OF THE PHYSICAL STATE OF A MONITORING OBJECT AT A MEASUREMENT POINT

(71) Applicants: Anatoly Alekseevich Speranskiy, Moscow (RU); Alexander Igorevich Prokhorov, Moscow (RU)

(72) Inventors: Anatoly Alekseevich Speranskiy, Moscow (RU); Alexander Igorevich Prokhorov, Moscow (RU)

(21) Appl. No.: 13/821,332

(22) PCT Filed: Sep. 7, 2010
(86) PCT No.: PCT/RU2010/000484

§ 371 Date: Mar. 7, 2013

(51) Int. Cl. G06T 15/00

(52) U.S. Cl. CPC G06T 15/005
USPC 345/419

(57) ABSTRACT

The invention relates to the field of continuum mechanics and is intended for evaluating the stress-strain state of objects in mechanical systems. The method comprises measuring a spatial vibration, storing a set of vectorial strain values and reproducing a spatial hodograph of the measurement point. Furthermore, in synchronism with the measurements, analytical synthesis of 3Dsuperposition of the measurement spectrum is performed and a set of vectorial stress values is stored. Diagnostics of the stress-strain state of the object are performed on the basis of a visual model presented in the form of a spatial three-dimensional graph of the physical state of a monitoring object at a measurement point which, in associated form, represents Hooke's law and Poisson law. The invention makes it possible to represent, in real time, the current life of the structural strength of the monitoring object, and to increase the information content and reliability of the evaluation of the physical state of monitoring objects.

### CROSS-REFERENCE TO RELATED APPLICATION

This application claims the benefit of the priority filing date in PCT/RU2010/000484 and referenced in WIPO Publication No. WO2012/033425. The earliest priority date claimed is Sep. 7, 2010.

### FEDERALLY SPONSORED RESEARCH

None

### SEQUENCE LISTING OR PROGRAM

None

### BACKGROUND

The given invention relates to the field of continuum mechanics, particularly, to methods of 3D-image reconstruction of the physical condition of a monitoring object in a measuring point. The invention is intended for evaluating the stress-strain state of mechanical system objects and might be used for evaluating and prognosticating anthropogenic safety.

A characteristic strain registration method is known. It Diagnostic variables of a research object element state are measured with the help of vibration pickups oriented in three directions: vertical, diametrical and longitudinal. The diagnostic variables are kept in a computer in the form of a digitized amplitude-time acceleration characteristic and it is processed using the Fourier transform for obtaining amplitude-frequency characteristics. (Patent RU Nr. 2250445, 28.04.2004, cl. G01 M 7/00).

Disadvantages of these methods are: 1. Measurements of strain spatial parameters in measuring points, related by fundamental laws of mechanics, are carried out using a scalar measuring tool set installed in three mutually perpendicular directions. At the same time, they are separated in space, which reduces the reliability of diagnostic variable strain measurements.

2. The processing of systematically unrelated measured and digitized amplitude-time acceleration characteristics using the Fourier transform leads to systematically unrelated amplitude-frequency characteristics that distorts the results of harmonic, statistical and correlation analysis. This means that the physical processes and phenomena in research objects are inadequately observed.

3. During the process of measuring (monitoring) and processing (reconstruction), the most important characteristic of the systematically related wave in essence fluctuation processes—the fluctuation phase of the diagnostic variables, is not taken into account. For reliable evaluation of the strain state of mechanical system objects, it is necessary to construct systematically related space-time amplitude, phase-frequency characteristics—spectral strain locus—using measurement processing vector-phase methods.

5. The method does not provide the correct position of measuring points towards the cybernetic 3D-image of the monitoring object that abstracts the measuring system from the object state.

6. The absence of a natural physical connection of measured diagnostic variables within the evaluation method, with space-time influence parameters generating them, significantly reduces the method's efficiency.

The closest technical solution for the declared method is a method of 3D-image reconstruction of the monitoring object's physical condition in a measuring point, including at least one measuring tool for simultaneous measuring of three orthogonal projections of the spatial vibrations' acceleration vector, obtaining the full range of amplitude-frequency and phase information in regards to monitoring object's strain state vector in a measuring point, storing a set of vectorial strain values and displaying a visual image of the spatial strains in measuring points (Patent RU Nr. 2371691, 22.04.2008, cl. G01 M 7/02).

The disadvantage of this method is that it is not possible to carry out a reliable evaluation of the monitoring object's physical condition because only one diagnostic variable (strain) in space and time is used in this method to characterize the stress-strain state.

The technical result of the declared method is increased reliability and awareness of the monitoring object's physical condition.

### SUMMARY

A method that reconstructs a 3D-image of the monitoring object's physical condition in a measuring point, including at least one measuring tool for simultaneously measuring three orthogonal projections of the spatial vibrations' acceleration vector; obtaining the full range of amplitude-frequency and phase information in regards to the monitoring object's strain state vector in a measuring point; storing the set of vectorial strain values and displaying a visual image of the spatial strain in measuring points; synchronously measuring information concerning the monitoring object's vectorial stress-strain state, while analytically synthesizing the 3D-superposition voltage spectrum values, before displaying the visual image on a monitor, with the help of equations for determining the cause-effect relationship parameter based on fundamental laws of mechanics, and substantiated by Hooke's and Poisson's laws regarding spatial fluctuations of a measuring tool's sensing element by reverse 3D-superposition tensor transformation of the measuring point's set of strain values (measurement); storing the set of vectorial strain values and a visual image of the monitoring object's physical condition in a measuring point in the form of a spatial three-dimensional hodograph displayed on a computer monitor, according to which the diagnosis of its stress-strain state is carried out.

### DRAWINGS

FIG. 1 presents the spatial three-dimensional hodograph of the physical condition of the monitoring object in a measuring point. There is a device block diagram at FIG. 2 which shows implementation of the declared method. FIG. 3 provides a measurement graph concerning the dynamics of electrical voltages in time, obtained while monitoring the object in accordance with a method prototype. FIG. 4 presents a measurement graph of the displacement dynamics over time, obtained while monitoring the object using the declared method. FIG. 5 provides a measurement graph of the strength dynamics, obtained while monitoring the object using the standard method (the snapback percussion method).

A block diagram of a device includes:

Block 1—the spatial fluctuation measuring tool, which is a 3D-receiver, described in patent RU Nr. 2383025, measures all the vector components under full synchronism and provides a full range of amplitude-frequency and phase information regarding the monitoring object's deformed state vector which is connected to the input of block 2.

Block 2 shows three-way matching blocks, synchronous transmission, analog-digital transformation and input of the strain parameters' measured components to a processor.

Block 3—a digital storage device of the strain parameters' measured components.

Block 4—spectral processing and component setting block of the measured strain parameters.

Block 5—a spectral reconstruction block of the strain parameters' space-time elliptical locus strain in measuring points.

Block 6—a reconstruction block of the monitoring object's 3D-model project parameters.

Block 7—a stress-strain state block where the reverse tensor transformation of the set of vectorial strain values into the set of voltage vectorial strain values is carried out.

Block 8—a diagnostic variable visualization block.

Block 9—a documentation block.

Block 10—a measurement and calculation system synchronization block in real time.

Block 11—an organization block of the system interaction of all blocks.

In this case, information transfer and management are carried out with the help of buses 12 to which block 2-10 outputs are connected.

Blocks 2-10 and software, employed in a device are standard and they are described in the LabVIEW SignalExpress National Instruments.

### DESCRIPTION

The essence of the declared method is that three orthogonal projections of the acceleration vector are simultaneously measured by at least one spatial fluctuation measuring tool 1, obtaining a full range of amplitude-frequency and phase information about the deformed state vector of the monitoring object in a measuring point and sending it to a unit 2 for processing. The set of vectorial strain values stored in unit 3. The stored set of vectorial strain values is subjected to spectral processing and setting in a unit 4. Afterwards, information concerning the set of victoria strain values arrives in a unit 5 where the reconstruction of the space-time elliptical locus is carried out, which are spectral diagnostic variables, reflecting the change dynamics of the linear dimensions of the monitoring object's continuum in measuring points. The projected 3D-model of the monitoring object is reconstructed in unit 6. In unit 7, with the help of equations for determining the cause-effect relationship parameter based on fundamental laws of mechanics (substantiated by Hooke's and Poisson's laws regarding spatial fluctuations of a measuring tool's sensing element by reverse D-superposition tensor transformation of the measuring points' strain measurement spectrum), the stress-strain states are simultaneously carried out while measuring and analytically synthesizing the 3D-superposition voltage spectrum.

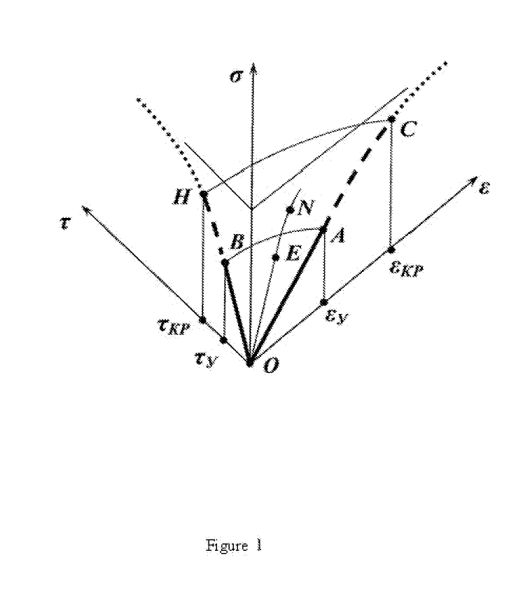

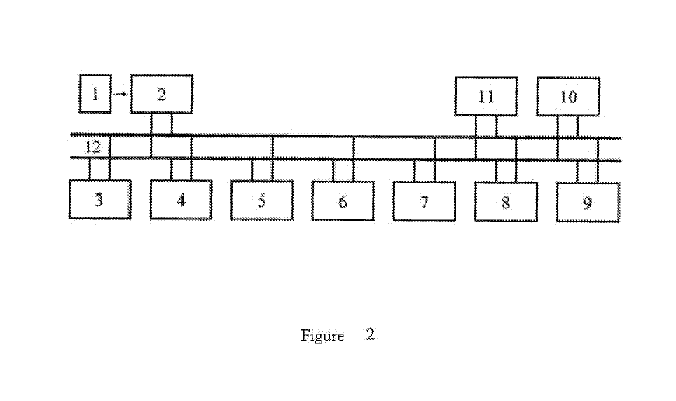

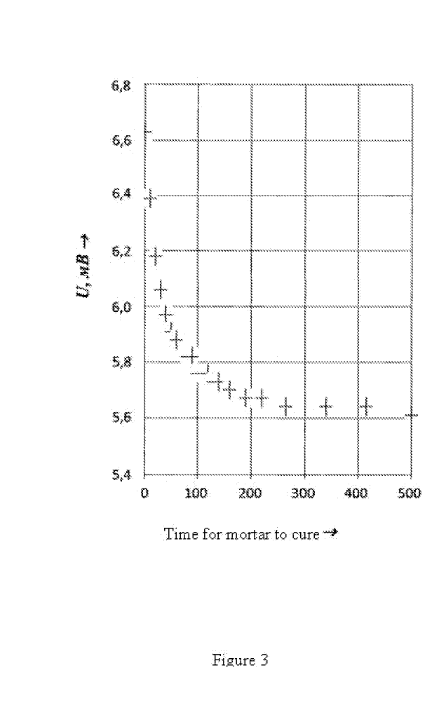

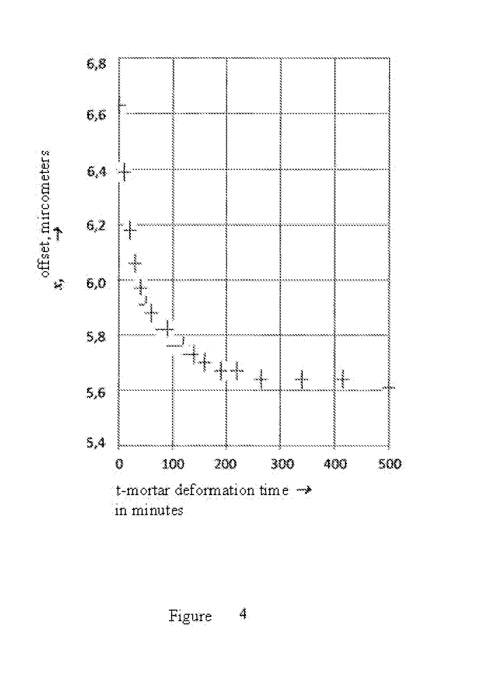

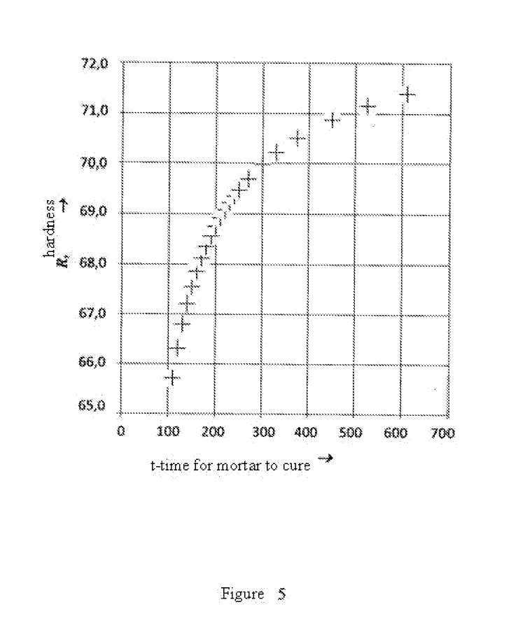

The fundamental laws establish a one-to-one correspondence between the cause, in the form of a linear or distributed external force factor, and effect, a voltage which affects the research object, and as a consequence, is in the form of volume-weight distributed external forces in a monitoring object environment and elastic strains, together forming the factor Triad of energy nature solidity. In this case, the Hooke's law establishes linear voltage correspondence a with normal strains of tension-compression E in accordance with the Hooke's laws σ=εE, but Poisson's law τ=γG establishes the linear strain correspondence y with shear tangent strain τ. Both laws describe real physical processes and have independent meaning in mechanics. They are based on the fundamental laws and general principles of continuum mechanics, as well as the principles of continuity and superposition, which is why distribution of elastic strains under normal voltage action have continued normally tangent spatial distribution (FIG. 1) in the Cartesian coordinates, the two extremes of which are found in Hooke's laws (normal plane σOε) and Poisson's laws (tangential plane which is orthogonal to the normal one σOσ).

The set of voltage vector values is then stored and a visual image in the form of a spatial three-dimensional hodograph of the monitoring object's physical condition in a measuring point is displayed on a computer monitor (block 8), according to which diagnosis of its stress-strain state is carried out.

For the visual image's spatial strain to be reliable, and to ensure that the processes are adequately observed, it is important to carry out real time system synchronization of the measured and reconstructed component parameters in blocks 10 and 11.

In a diagram (FIG. 1), the physics of the research object's stress-strain state is displayed with elastic strain linear areas OA and OB and elastic-plastic strain areas AC and BH, with points C and H being the critical strain boundary. Casual transformation coefficients reflect system character and are related to the tensor corresponding tensor matrix. Therefore, on the basis of adequately measured natural synthesis, and with the help of spatial fluctuation measuring tools, a spectral component set of strain vectors by reverse physical tensor transformation, creates the possibility for an objectively reliable vector-phase analysis and reconstruction of an estimated spectral set of voltage vector components, or of the contour surface of a monitoring object's measuring points, in a reasonably selected capacity.

With the help of known computer and graphical methods, vector-phase 3D-reconstruction of diagnostic variables in real time measuring points in diacritic state areas O-A-C- H-B-O of a monitoring object's contour surface permits analysis of current state deviation from the projected one. For example, point E is located in an elastic state area, but point N is located in an elastic-plastic state area with some reservation concerning the boundary of the critical state C H area. The space-time reconstruction of a diacritic state area O-A-C- H-B-O for simplifying the analysis might be presented visually on a display (block 8) or documented (block 9).

For each measured or approximated point of a monitoring object's contour surface, with the exception of generally accepted diagnostic variables, a certain point on a spatial three-dimensional hodograph of the monitoring object's physical condition in a measuring point uniquely corresponds to each period of time at each frequency range. This hodograph presents Hooke's and Poisson's laws in a related way for the first time in a way that reflects the natural laws of solidity mechanics and unites normal voltages with normal and tangent strains, which in their turn are the phase parameters of the determining equations in the fundamental law connection. The level of closeness of a measuring point location to the elastic-plastic strain area's boundary permits consideration of the current level of operational resource-strengthening parameters of structural strength.

The given hodograph, in addition to presenting coordinates GET, can be presented in any set of a monitoring object's physical parameter state.

An example of the method. One of the practical confirmations of the declared method's effectiveness is the observation dynamics in the change process of a property's strength during the process of hardening composite artificial stone on the basis of cement (concrete). The most widely used were indirect methods for this purpose—elastic snapback and shock-vibrational. The principal feature of the mentioned evaluation methods for material mechanical properties is that the indirectly measured value is not the strength. Instead, the value is a correlated surface strength related to calibration dependence strength. At the same time, the value of the material's strength is inversely proportional to the elastic displacement of particles under the influence of harmonic effect. Classical modal analysis' “shock-vibrational strength express-evaluation by a one-point test method” is also indirect and does not provide other parameters, except for the averaged strength in the direction of an impact snapback. Vibratory methods based on direct measurements of mechanical responses over exposures are not virtually claimed to date due to low awareness and reliability of most widespread one-component vibration sensors. The offered method, using a spatial fluctuation 1 measuring tool, does not require impact. The method implements direct measurement of physical condition diagnostic variables. At the same time, a very high measurement result convergence is observed towards the disturbance direction impact using the declared (FIG. 4) and known method (indirect methods)—FIG. 3 (the prototype method) and FIG. 5 (the standard method).

In the making process (material hardening) and further in the process of operational monitoring, comparative tests support the possibility and appropriateness of using the method for dynamics research in hardening change. As a consequence of environment elasticity from the main wave, other waves are generated in other areas, particularly, in a plane X-Y, which is perpendicular to the direction of perturbation action. Fluctuations in the X-Y plane depend on elastic environment material stiffness: during the hardening process, strength increases and displacement of particles decreases. Application of a spatial fluctuation measuring tool 1 allows for not only determining longitudinal wave parameters in the direction of perturbation action Z, but also for spatial monitoring of elastic stiffness in the shear plane X-Y which is the impact perpendicular to the main direction of the object's operational structural strength. At the same time, a position on the spatial three-dimensional hodograph of the monitoring object's (FIG. 1) physical condition of a measuring point E (which is the strain signal asymptote X in time on the displacement measurement dynamics graph in time, FIG. 4) concerning the elastic area boundary OAB, elastic-plastic ACHB and limiting states CH, allows for reasonably considering the structural strength of the current resource parameters in real time. It is especially topical while building and operating such facilities of high anthropogenic danger such as foundations for nuclear power plants, monorail communications, cable systems, landing airfield strips, construction spans, dams, bridges, tunnels, bearings, underground transport facilities, and all monolithic high-rise constructions.

Another practical proof of the declared method's effectiveness is the ability to accurately determine spatial vector orientation and absolute value vibration to dramatically improve the definition reliability of correction mass to comply with a compensating part of the distributed imbalance shafting. At the same time, the measuring point displacement trend to the coordinates' origin on the spatial three-dimensional hodograph of the monitoring object's physical condition in a measuring point, attests to a decrease of imbalance in the observed correction plane. The six-bearing shafting, balancing GTU-100-3 of generating capacity 100 MWt by the declared method, allows for original bearing vibration in all measurement directions to be reduced 2-2.5 times (during one iteration) lower than the standard level allowed by PTE and GOST 25364-98 for long-term operation. This eliminates the need for corrective launches, which are usual for this class of machinery.

The method also got practical confirmation while reconstructing a 3D-image of the physical condition of a turbo unit bearings T-250/300-240 in a measuring point. In addition to traditional forms of presentation (tables, spectrums and polar diagrams), a new type of vibration presentation was implemented for the first time—a motion path (locus) of measuring points projected on an orthogonal plane of the spatial fluctuation measuring tools' 1 Cartesian coordinates. It is not difficult to reproduce the spatial locus of a measuring point according to the projection parameters—the three-dimensional image reconstruction of the physical condition.

Construction contour characteristic and fluctuation form analysis in regular absolute vibration control points of allowed for more fully and accurately evaluating the current vibration state, control element tracking changes of measured vibrational characteristics (the fluctuation forms and motion path within planes and space), and their real time interaction with each other. This may reveal slackening in a turbo unit's supporting construction. On the basis of the measured parameters, corresponding voltage analytical parameters are defined for characterizing exposures. This confirms the advantages of vector measurements for the purposes of vibrational adjustment, diagnosis and power-generating set balancing of heat-and-power facilities.

Technical and economic advantages of the declared method in comparison with the prototype includes an increased awareness and evaluation reliability of a monitoring object's physical condition resulting from reconstruction of time related multidimensional images of a physical conditions' diagnostic variable. In addition, the declared method for the first time provides for the possibility of an instrumental reflection of the structural strength of a monitoring object's current resource in real time.

What is claimed:

1. A method of 3D-image reconstruction of a monitoring object's physical condition in a measuring point, including
at least one measuring tool for simultaneously measuring three orthogonal projections of an acceleration vector of spatial vibrations,
obtaining a full range of amplitude-frequency and phase information about a strain state vector of the monitoring object in a measuring point,
storing a set of vectorial strain values and displaying a visual image of spatial strains in measuring points on a computer monitor
wherein, before displaying the visual image on a monitor, information concerning the monitoring object's vectorial stress-strain state is synchronously measured while analytically synthesizing 3D-superposition voltage spectrum values with the help of equations for determining the cause-effect relationship parameter of the fundamental laws of mechanics, and substantiated by Hooke's and Poisson's laws regarding spatial fluctuations of a measuring tool's sensing element by reverse 3D-superposition tensor transformation of the measurement spectrum,
storing the voltage spectrum values and the visual image in the form of a spatial three-dimensional hodograph of the monitoring object's physical condition in a measuring point displayed on a computer monitor, according to which diagnosis of its stress-strain state is carried out.
